(19) United States
(12) Patent Application Publication
(10) Pub. No.: US 2010/0058638 A1
(43) Pub. Date: Mar. 11, 2010

(54) Identity labeling system for electrical cover plates

(76) Inventors: John Patrick Askin, Prospect, KY (US); Steven T. Steurer, Louisville, KY (US)

Correspondence Address: STEVEN T. STEURER, 5 EDMONIA AVE, LOUISVILLE, KY, 40202, US

(21) Appl. No.: 12/283,256

(22) Filed: Sep. 11, 2008

(51) Int. Cl. G09F 3/18

(52) U.S. Cl. 40/661

(57) ABSTRACT

Identity labeling system for a typical tight switch cover plate (5) used in a manner that is common for covering typical light switches and their electrical connections. The switch plate cover includes openings (25) that expose the electrical switches or devices and holes (35) to accept screws (45) that secure the switch plate cover onto the wall to cover the electrical connections. The improved method of labeling an existing switch plate comprises a label cover plate (15) attached to the switch cover plate (5) with the existing screw (45) that typically secures an existing switch cover plate to the wall. The cover plate is made of a clear material. The cover plate (15) includes a recess (55) in the back of the cover to hold the identity label (95) tabs (65) and grooves (75) to insure correct alignment during installation. The identity label (95) is a typical label that is used in offices to identify file folders. The labels come in perforated sheets (85) that can be imprinted by running them through a common computer printer to customize the labels to be used in any location to identify the switch.

### FIELD OF THE INVENTION

This application relates generally to the field of electrical fixtures and cover plates and more specifically techniques and methods for labeling said fixtures to make the use of the fixtures more convenient.

### BACKGROUND OF THE INVENTION

In both homes and commercial establishments, electrical cover plates are conventionally attached to the walls to cover the electrical connections of light switches. Use of this type of switch cover plate is well known in the art. Typically, the switch cover plate is secured to the receiving surface by screws. In an example of a light switch, as is well known, a light is typically turned on and off by flipping the light switch in the appropriate on or off position. It is common for several switches to be located in one general region covered by one larger multiple cover plate, such as a door or at the top of a stairway. In order to visually identify which light needs to be turned on or off by a certain light switch, a stick-on label or tag such as a “Dymo” label may need to be affixed to the cover plate identifying the particular light controlled by that light switch so a person can insure that they are flipping on or off the correct light or electrical device. The above mentioned Dymo labels provide only a temporary and not a very attractive solution because they become unglued and scratch over time due to normal use. They identify the switch but do not provide the appearance that most home and building owners would consider a permanent attractive solution to the problem.

The prior art has shown some attempts to solve the problems with electrical cover plates set forth above. For example U.S. Pat. No. 6,178,681 discloses a tag that identifies an electrical that is attached to the cover plate. This tag is over sized and uses handwritten labels that are paper. U.S. Pat. No. 7,270,436 B2 discloses a backlit plate with a label but it is attached to the electrical supply in the structure and only works if the electricity is being supplied to the electrical device. This type of label is not easily retrofitted to existing switch plate cover because it takes knowledge of electricity to install. U.S. Pat. No. 6,929,837 discloses a removable tag that identifies a tag that is attached to the cover plate. This tag is not meant to be a permanent solution to the above mentioned problems. And U.S. Pat. No. 5,212,899 discloses a tag that identifies a tag that is attached to the cover plate. It uses a separate back plate with a plastic cover and the tag is that is not easy for the end-user to customize.

Thus, there is a need for a switch and outlet cover plate which is specifically designed to solve the above-described problems.

### SUMMARY OF THE INVENTION

Thus, it is the object of the present:invention to provide a light switch cover plate that is clearly labeled with a method that is both inexpensive and an attractive permanent solution.

It is another object of the present invention to provide a solution that is easy for the novice person with very little electrical and construction skills to install new or to retrofit the device onto the many unidentified covers plates that are currently in use.

In the preferred embodiment of the present invention, a typical electrical switch plate that are well known in the art is used and a combination label and label cover is mounted to identify the light or electrical appliance that is controlled by the switch.

In the preferred embodiment of the present invention this additional identity plate consists of two parts; label cover and a label. The label cover is made up of a clear hard martial such as plastic so it will protect the label during normal use. The paper labels are made up of a typical label that is used in offices to identify file folders. The labels come in perforated sheets that can be imprinted by running them through a common computer printer to customize the labels to be used in any location to identify the switch. The label cover holds the label in a recess so that the label can be seen through the clear surface of the label cover.

The label cover plate is mounted to the typical electrical cover plate by simply removing one of the screws from the existing holes in the cover plate that secures the switch plate to the wall. The screw is then inserted through the identity plate and tightened to hold the label cover plate in position on the switch cover plate trapping the paper label between the label cover and the switch cover plate. A tab and groove combination at the ends of the covers ensures alignment and allows the use of multiple cover plates for multiple switch cover plates. This combination is an attractive permanent solution for identifying electrical connections.

It will be seen that the technical advantages of the invention includes a clear label cover and use easy to customize and readily available labels to provide a unique solution to this common problem.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates an embodiment of the invention showing a switch cover plate with the label cover and label attached in the existing upper hole of a typical electrical cover plate.

FIG. 2 illustrates an embodiment of switch cover plate with the overlay illustrated in a separated view to show the assembly method.

FIG. 3 illustrates an embodiment of the invention showing a switch cover plate with the label cover and label attached in the existing lower hole of a typical electrical cover plate.

FIG. 4 illustrates a sheet of customizable identity labels.

### DETAILED DESCRIPTION OF THE INVENTION

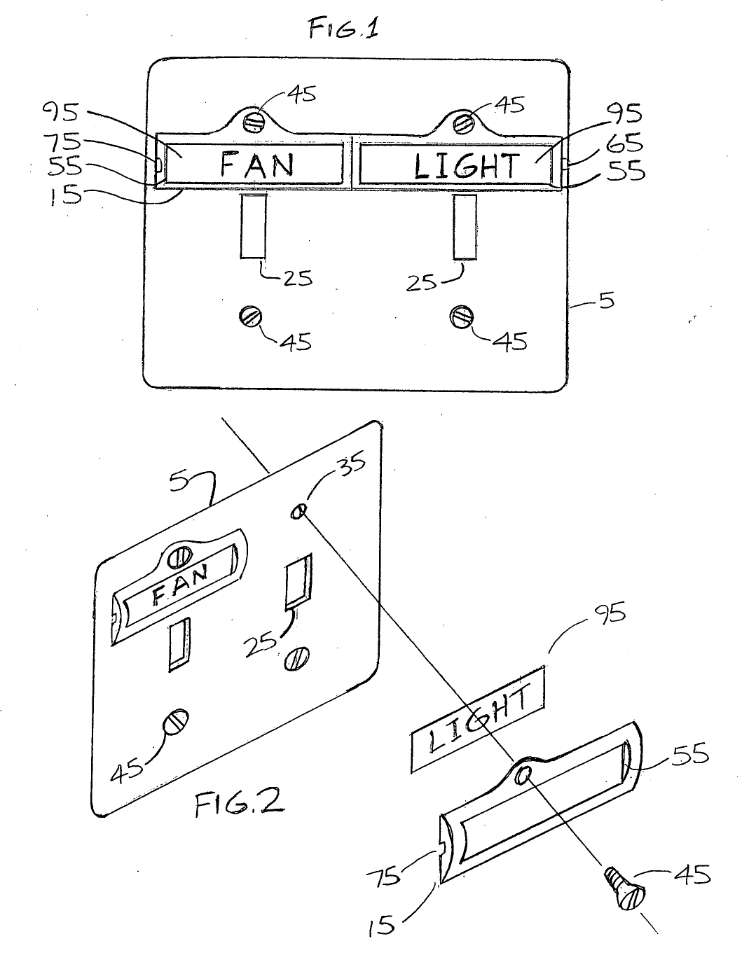

FIGS. 1-4 show a typical light switch cover plate (5) used in a manner that is common for covering typical light switches and their electrical connections. The switch plate cover includes openings (25) that expose the electrical switches or devices and holes (35) to accept screws (45) that secure the switch plate cover (5) onto the wall to cover electrical connections. The present invention (10) comprises a combination label (95) label cover plate (15) to identify the device that is controlled with the electricity that is supplied by the switch. It is attached to the switch cover plate (5) with the existing screw (45) that typically secures the switch cover plate (5) to the wall. The label cover (15) is made of a clear material. The label cover (15) includes a recess (55) in the back of the cover to hold the identity label (95) tabs (65) and grooves (75) to insure correct alignment during installation. The identity label (95) is a typical label that is used in offices to identify file folders. The labels come in perforated sheets (80) that can be imprinted by running them through a common computer printer customize the labels to be used in any location to identify the switch.

FIG. 1 illustrates an embodiment of the present invention (10) showing a typical electrical switch cover plate (5) with the label cover (15) and label (95) attached in the existing upper holes (35) of a switch cover plate (5).

FIG. 2 illustrates an embodiment of switch cover plate (5) with the label cover (15) illustrated in a separated view. This view shows how the present invention uses the label cover (15) traps the label (95) in a recess (50). It also illustrates the manner in which the existing screws (45) are used to attach the present invention (10) to the electrical switch plate cover.

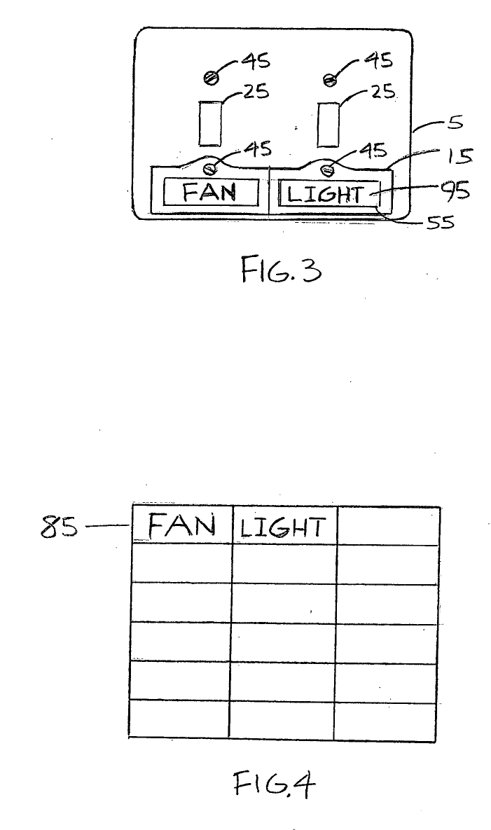

FIG. 3 illustrates an embodiment of the present invention (10) showing a switch cover plate (5) with the label cover (15) and label (95) attached in the existing lower holes (35) of a typical electrical cover plate (5). This illustration provides another option for the user to attach the present invention (10) to an existing switch plate cover (5).

FIG. 4 illustrates a sheet of identity labels (95) the labels are typical labels used in offices to identify file folders. The labels come in perforated sheets (85) that can be imprinted by running them through a common computer printer to customize the labels to be used in any location to identify the switch.

As described above in the summary sections the present invention (10) a clear label cover (15) combined with a customizable label (95) that is separate from and is not an integral part of a typical electrical cover plate (5), but that is attached using the existing screws (45) from the electrical cover plate (5), is idea for use to identify electrical switch plate cover (5) and the devices that they control, it should be understood that the present invention may find alternate uses such as night lights and reading lights for small spaces.

Although the present invention and its advantages have been described in detail, it should be understood that various changes, substitutions and alterations can be made herein without departing from the spirit and scope of the invention as defined by the appended claims.

1. An identity labeling system far use with electrical cover plates comprising:
a clear plastic cover with a attachment hole and a label recess in the rear surface of said clear plastic cover to accept a paper identity label;
a paper label that comes in a perforated sheet that can be customized with a common computer printer and printed using software to align the print and center it on each label;
a screw hole in the plastic cover placed so that it can be mounted to an existing electrical cover plate by removing one of its attachment screws and passing said screw through the plastic cover securing it cover plate and paper label to the exterior surface of said electrical cover plate.

2-3. (canceled)

4. A method of labeling and existing electrical control switch that include an existing cover plate to inform the user of what electrical device is powered and controlled by said switch comprising:
(a) Removing one of the screw that holds the cover plate on the electrical control switch;
(b) Using that same screw to attach said labeling system to the exterior of the existing cover plate that includes;
a. A printed paper or plastic identity label made from paper or plastic sheet material;
b. A hard clear label cover that covers the label to hold it in place and protect it from normal use;
c. A means at each end of the clear label cover to ensure alignment and allow the use of multiple covers for multiple device cover plates.
